(19) United States
(12) Patent Application Publication
(10) Pub. No.: US 2016/0034219 A1
(43) Pub. Date: Feb. 4, 2016

(54) SYSTEM AND METHOD OF CALIBRATION OF MEMORY INTERFACE DURING LOW POWER OPERATION

(71) Applicant: Apple Inc., Cupertino, CA (US)

(72) Inventors: Robert E. Jeter, Santa Clara, CA (US); Neeraj Parik, San Jose, CA (US); Kai Lun Hsiung, Fremont, CA (US)

(21) Appl. No.: 14/450,525

(22) Filed: Aug. 4, 2014

(51) Int. Cl. G06F 3/06

(52) U.S. Cl. CPC G06F 3/0625; G06F 3/0634; G06F 3/0683

(57) ABSTRACT

A system includes memory unit having one or more storage arrays, and a memory interface unit that may be coupled between a memory controller and the memory unit.

The memory interface unit may include a timing unit that may generate timing signals for controlling read and write access to the memory unit, and a control unit that may calibrate the timing unit at predetermined intervals. The memory interface unit may be configured to operate in a normal mode and a low power mode. However, in response to an occurrence of a given predetermined interval while the memory interface unit is in the low power mode, the memory interface unit may be configured to calibrate the timing unit subsequent to transitioning to the normal mode.

### BACKGROUND

1. Technical Field

This disclosure relates to memory systems, and more particularly to memory interface calibration.

2. Description of the Related Art

Power consumption by electronic devices has been a growing concern for some time. However with the proliferation of mobile devices like mobile phones, tablets, computers and the like, reducing power consumption has become a key design metric. As such, designers are constantly looking for ways to reduce the amount of power consumed by the devices they develop.

There are many ways to reduce power consumption of a device. One mechanism to reduce power consumption is referred to as clock gating in which one or more clock signals that are provided to a device or a portion of a device are stopped when that device or portion isn't being used. The stopped clock reduces the device transistor transitions, and thus reduces the power consumed. Another mechanism is referred to as power gating in which the supply voltage provided to a device or a portion of a device is removed when that device or portion isn't being used. In some cases combinations of clock and power gating may be used for even greater reductions.

While these power reduction mechanisms work well, there can be drawbacks. For example, depending on the type of device it may take several clock cycles or some amount of time for the device to return to full operation after a clock or power gate operation. In some cases, the amount of time to return to full operation may be unacceptable, but there may still be a requirement to reduce power.

### SUMMARY OF THE EMBODIMENTS

Various embodiments of a system and method of calibrating a memory interface while reducing power are disclosed. Broadly speaking, a memory system includes a memory interface unit that controls read and write access to a memory unit by controlling the timing signals to the memory unit. The memory interface unit may also calibrate the timing signals at predetermined intervals to compensate, for example, process, voltage and temperature drift. The memory interface may also operate in a low power mode. In response to an occurrence of a given predetermined interval while the memory interface unit is in the low power mode, the memory interface unit may be configured to transition to the normal mode, and then calibrate the timing unit.

In one embodiment, a system includes memory unit having one or more storage arrays, and a memory interface unit that may be coupled between a memory controller and the memory unit. The memory interface unit may include a timing unit that may generate timing signals for controlling read and write access to the memory unit, and a control unit that may calibrate the timing unit at predetermined intervals. The memory interface unit may be configured to operate in a normal mode and a low power mode. However, in response to an occurrence of a given predetermined interval while the memory interface unit is in the low power mode, the memory interface unit may be configured to calibrate the timing unit subsequent to transitioning to the normal mode.

In one particular implementation, the memory interface unit may also return to the low power mode subsequent to completion of calibration of the timing unit and in response to continuing to receive an asserted idle signal from the memory controller. In one embodiment, the memory controller may assert the idle signal dependent upon memory traffic between the memory controller and the memory unit.

### BRIEF DESCRIPTION OF THE DRAWINGS

FIG. 1 is a block diagram of one embodiment of an integrated circuit including a memory interface having a DLL and a control unit.

FIG. 2 is a block diagram illustrating more detailed aspects of an embodiment of the memory interface shown in FIG. 1.

FIG. 3 is a flow diagram describing operational aspects of the memory interface shown in FIG. 1 and FIG. 2.

FIG. 4 is a block diagram of one embodiment of a system that includes the integrated circuit of FIG. 1.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph (f), interpretation for that unit/circuit/component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

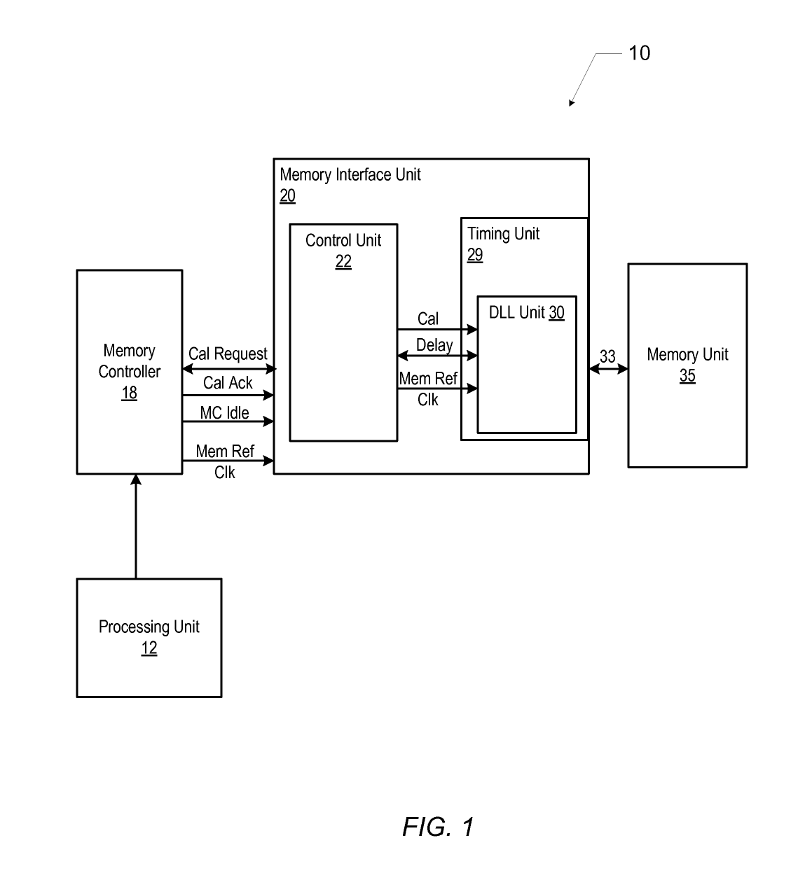

Turning now to FIG. 1, a block diagram of one embodiment of an integrated circuit including a memory interface is shown. The integrated circuit 10 includes a processing unit 12 that is coupled to a memory controller 18. The memory controller 18 is also coupled to a memory interface unit 20, which is in turn coupled to a memory unit 35 via a memory interconnect 33. In one embodiment, the integrated circuit 10 may be considered as a system on a chip (SOC).

In various embodiments, the processing unit 12 may include one or more processor cores and one or more cache memories (not shown). The processor cores may execute application software as well as operating system (OS) software. The OS may control various features and functions of the integrated circuit.

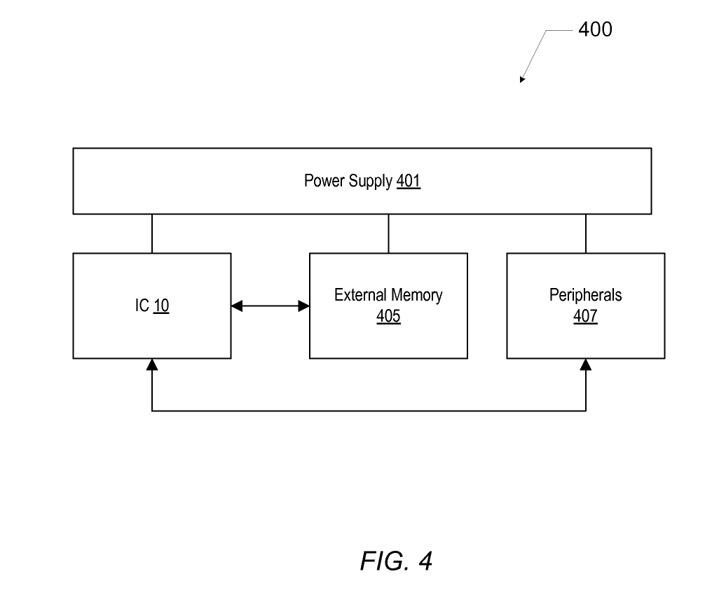

The memory unit 35 may be representative of any type of memory. In one embodiment, the memory device 35 may be representative of one or more random access memory (RAM) memory devices in the dynamic RAM (DRAM) family of devices as described below in conjunction with the description of FIG. 4. Accordingly, the memory interconnect 33 may include a number of data paths, data strobe paths, and address and command paths (all not shown).

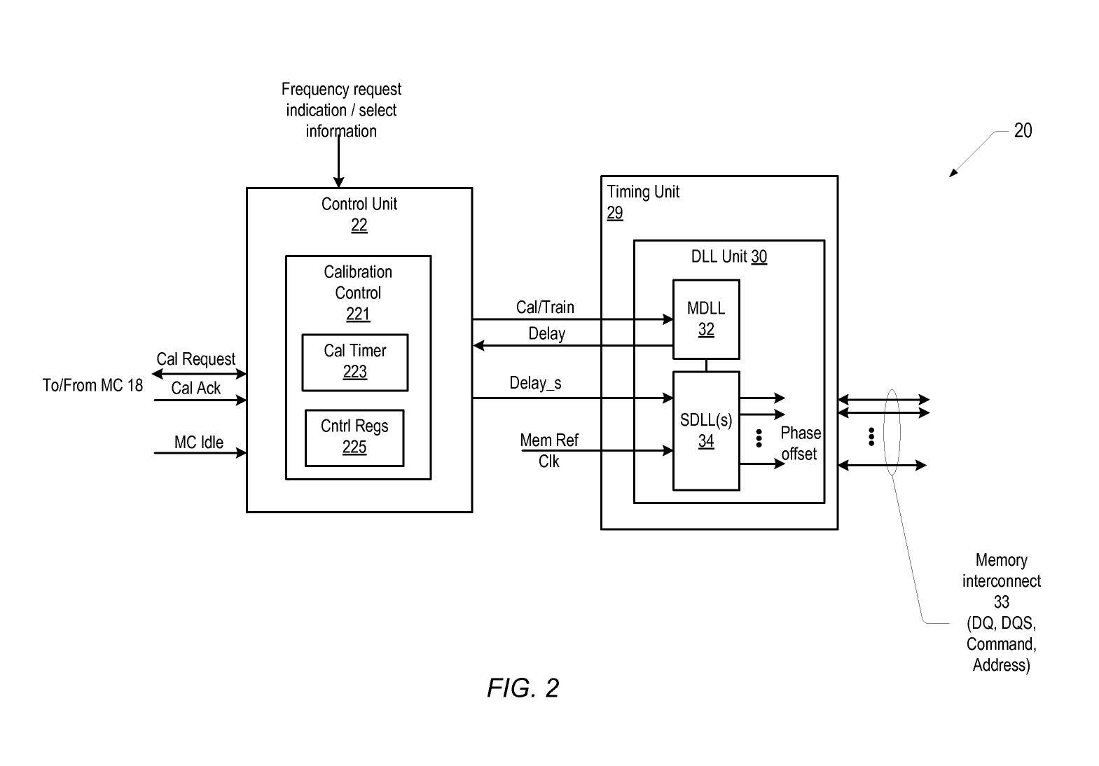

In one embodiment, the memory interface unit 20 may serve as a memory control and configuration interface. As such the memory interface unit 20 of FIG. 1 includes a control unit 22 and a timing unit 29. The timing unit 29 includes a delay locked loop (DLL) unit 30. In various embodiments, the DLL unit 30 may include a master DLL (MDLL) (shown in FIG. 2) that may be configured to acquire and lock onto a particular edge of a memory reference clock, and one or more slave DLLs (SDLLs) (shown in FIG. 2) that may be configured to provide one or more delayed versions of a second reference clock for use by the memory interconnect 33. More particularly, in one implementation, the MDLL may be used to lock onto the memory reference clock and to provide one or more delay values used to delay the reference clock signal some number of clock cycles or partial clock cycles. The SDLLs may be used to control clocking on the memory interconnect 33 based upon the delay values provided by the MDLL. In particular, in one implementation the SDLLs may provide clock signals having a phase offset which may be used to place data strobes as close as possible to the center of the clock window of the memory interconnect 33. This centering may allow more variability in signal timing shift without missing data bits.

In one embodiment, the control unit 22 may be configured to calibrate and control the operation of DLL unit 30. In one embodiment, control unit 22 may use control registers and a calibration timer (both shown in FIG. 2) to control calibration operations such as training of the MDLL 32 and configuration of the phase delay of each of the SDLLs 34. In one embodiment, the control unit 22 may provide the delay values to the SDLLs 34 to generate clocks with the correct phase offset. In addition, the control unit 22 may provide the training signals to the MDLL 32 during a calibration sequence at predetermined intervals as described further below.

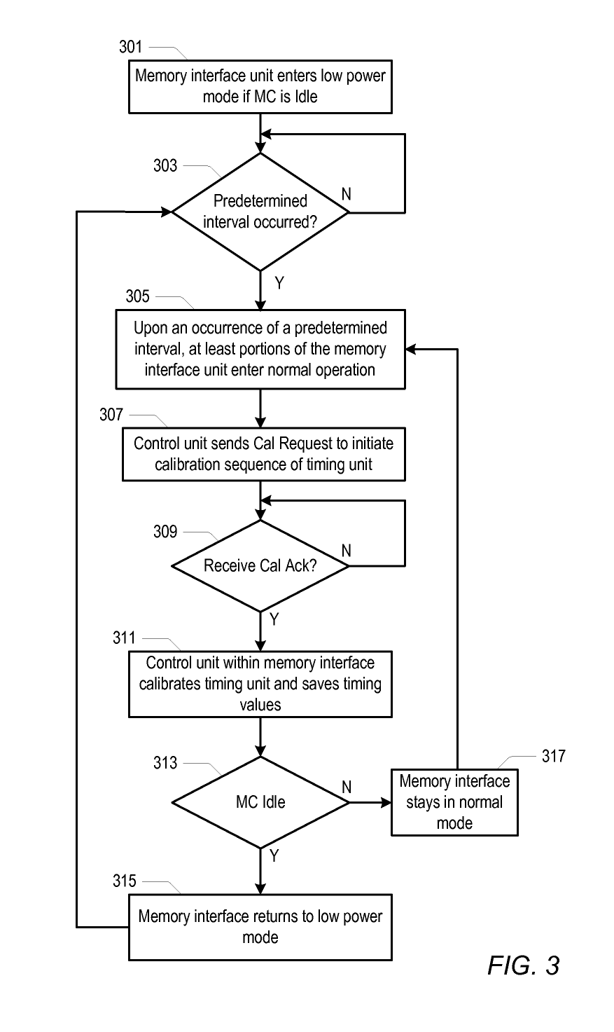

More particularly, as described in greater detail below in conjunction with the description of FIG. 2 and FIG. 3 the control unit 22 may be configured to calibrate the DLL unit 30 at predetermined intervals. Ongoing calibration may be necessary to due to various factors such as process, voltage, and temperature drift of the DLL unit 30 or the memory unit 35 or both. The result of the drift may be that the data eye shifts to such an extent that data may not be written to or read from the memory unit 35 in a reliable manner. Accordingly, the control unit 22 may request to perform a calibration sequence of the timing unit 29 at the predetermined intervals. If the request is granted by the memory controller 18, the control unit may perform the calibration sequence. The predetermined intervals may, for example, be determined during manufacture based upon the particular manufacturing processing and operating corners of the IC 10, the memory unit 35, or both. It is noted that a variety of calibration methods may be used. For example, in one embodiment, a predetermined data set may be read from the memory unit 35, while the read data eye is found. Once the read data eye is calibrated and the data set is reliably read, the write data eye may be calibrated. In one embodiment, a predetermined write data set may be written to the memory unit 35, and then subsequently read back.

It is possible that the memory interface unit 20 or at least portions of it may be placed in a low power mode of operation during which portions of the memory interface unit 20 may be powered down using power gating techniques. Alternatively, during the lower power mode various system clocks that feed portions of the memory interface unit 20 may be stopped using clock gating techniques. In some embodiments, the memory interface unit 20 may be placed in the low power mode due to inactivity of the memory controller 18, for example. However, regardless of whether the memory interface 20 is in the low power mode or a normal mode of operation, it may still be necessary to calibrate the timing unit 29. More particularly, as mentioned above voltage and temperature drift may cause the timing unit signals to shift such that the memory device cannot be read from or written to. Thus, the timing unit 29 may be calibrated at predetermined intervals. Because it is possible that the memory interface 20 may stay in the low power mode for extended periods, the resulting drift upon awakening could make the memory interconnect 33 unusable without a full calibration and initialization. A full calibration may take an unacceptable amount of time. Accordingly, as described in greater detail below, the memory interface unit 20 may be forced out of the low power mode to perform a calibration sequence at certain intervals, and once the calibration is complete, if the low power mode is still warranted, the memory interface unit 20 may be placed back into the low power mode. Doing so may ensure that the memory interface unit 20 is capable of memory operations as soon as possible upon awakening from the low power mode.

Referring to FIG. 2, a block diagram illustrating more detailed aspects of the embodiment of the memory interface unit 20 of FIG. 1 is shown. Components that correspond to those shown in FIG. 1 are numbered identically for clarity and simplicity. The memory interface unit 20 includes the control unit 22, which in turn includes a calibration timer 223 and control registers 225. The memory interface unit 20 also includes the timing unit 29, which includes the DLL unit 30. As shown, the DLL unit 30 includes an MDLL 32, and one or more SDLLs 34. In one embodiment, the timing unit 29 provides the hardware physical layer signaling to the memory interconnect 33. As shown, the SDLLs 34 provide one or more clocks having a phase offset, which may be used by logic within the timing unit 29 to provide data strobes (e.g., DQS), for example.

As described above, the control unit 22 may control the calibration sequence of the timing unit 29. During operation of the IC 10, the calibration timer 223 may be programmed to a particular value. The calibration timer may be any type of timer such as a count up or count down timer as desired. As such, the calibration timer may be configured to count up to or down to the programmed count value, and to notify the control unit 22. In response to the calibration timer 223 notification, the control unit 22 may send a calibration request to the memory controller 18. The memory controller 18 may be configured to determine whether the memory interface is too busy to perform a calibration at the time it receives a calibration request. The memory controller 18 may either grant the request with a calibration acknowledgement (Ack) or hold off the control unit 20 for some predetermined time interval.

If the calibration request is granted, the control unit 22 may initiate the calibration by signaling the MDLL 32 to initiate a training sequence to re-lock onto the Mem Ref Clk so that the control unit 20 may obtain new SDLL phase offsets for generation of data strobes. In addition, the control unit 20 may also initiate reads and writes to the memory unit 35 while adjusting various delay elements including SDLLs. Once the calibration timing values are obtained, the control unit 20 may write the calibration values to the control registers 22.

As mentioned above, the memory interface unit 20 may be placed in a low power mode for various reasons. For example, in one embodiment the memory controller 18 may detect inactivity on the memory interconnect 33 and responsively power down all or a portion of the memory interface unit 20. In one embodiment, the memory controller 18 may send an Idle signal to the memory interface unit 20. In response to the Idle signal, the memory interface unit 20 may be configured to enter a low power mode in which portions are power gated or powered down. However, during operation in the low power mode various circuits in the memory interface unit 20 may still be operating. For example, in one embodiment, the calibration timer 223 may continue to operate normally in the low power mode. Accordingly, when the calibration timer 223 elapses it may be configured to send a notification to the control unit 22. In response, at least portions of the control unit 22 may be powered up to send a calibration request to the memory controller 18, and to await a calibration Ack signal. When a calibration Ack is received, the control unit 22 may be configured to power up the remaining portions of the control unit 22 to perform the calibration of the timing unit 29.

FIG. 3 is a flow diagram describing operational aspects of the memory interface of FIG. 1 and FIG. 2. Referring collectively now to FIG. 1 through FIG. 3 and beginning in block 301 of FIG. 3, during operation of the IC 10, at least a portion of the memory interface unit 20 may be placed in a low power mode of operation as described above. During operation in the low power mode, the calibration timer 223 may continue to operate and count normally. Accordingly, the calibration timer 223 may check for the programmed count value. If the count value has not been reached (block 303) the timer 223 continues counting. However, if the count value has been reached (block 303), the calibration timer 223 may send a notification to the control unit 22 to initiate the calibration sequence of the timing unit 29 (block 307).

If the control unit 22 does not receive a Cal Ack from the memory controller 18, the control unit 22 waits (block 309). However, if the control unit 22 receives the Cal Ack from the memory controller 18, the control unit 22 may power up any remaining powered down circuits within the memory interface unit 20, and initiate calibration of the timing unit 29 as described above. Once the new calibration values have been received, the control unit 22 may save the values by writing them to the control registers 225 (block 311).

If the memory controller 18 is still providing the Idle signal to the memory interface unit 20 (block 313), the memory interface unit 20 may return to the low power mode of operation (block 315). Operation continues as described above in conjunction with the description of block 303. Otherwise, the memory interface unit 20 may continue to operate in the normal mode of operation (block 317). Operation continues as described above in conjunction with the description of block 305.

Turning to FIG. 4, a block diagram of one embodiment of a system that includes the integrated circuit 10 is shown. The system 400 includes at least one instance of the integrated circuit 10 of FIG. 1 coupled to one or more peripherals 407 and a system memory 405. The system 400 also includes a power supply 401 that may provide one or more supply voltages to the integrated circuit 10 as well as one or more supply voltages to the memory 405 and/or the peripherals 407. In some embodiments, more than one instance of the integrated circuit 10 may be included.

The peripherals 407 may include any desired circuitry, depending on the type of system. For example, in one embodiment, the system 400 may be included in a mobile device (e.g., personal digital assistant (PDA), smart phone, etc.) and the peripherals 407 may include devices for various types of wireless communication, such as WiFi, Bluetooth, cellular, global positioning system, etc. The peripherals 407 may also include additional storage, including RAM storage, solid-state storage, or disk storage. The peripherals 407 may include user interface devices such as a display screen, including touch display screens or multitouch display screens, keyboard or other input devices, microphones, speakers, etc. In other embodiments, the system 400 may be included in any type of computing system (e.g. desktop personal computer, laptop, workstation, net top etc.).

The system memory 405 may include any type of memory. For example, as described above in conjunction with FIG. 1, the system memory 405 may be in the DRAM family such as synchronous DRAM (SDRAM), double data rate (DDR, DDR2, DDR3, etc.), or any low power version thereof. However, system memory 405 may also be implemented in static RAM (SRAM), or other types of RAM, etc.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system comprising:
a memory unit including one or more storage arrays;
a memory interface unit coupled between a memory controller and the memory unit, wherein the memory interface unit is configured to operate in a normal mode and a low power mode, and wherein the memory interface unit includes:
a timing unit configured to generate timing signals for controlling read and write access to the memory unit; and
a control unit configured to calibrate the timing unit at predetermined intervals; and
wherein in response to an occurrence of a given predetermined interval while the memory interface unit is in the low power mode, the memory interface unit is configured to calibrate the timing unit subsequent to transitioning to the normal mode.

2. The system of claim 1, wherein the memory interface unit is configured to enter the low power mode in response to receiving an asserted idle signal from the memory controller.

3. The system of claim 2, wherein the memory controller is configured to assert the idle signal dependent upon memory traffic between the memory controller and the memory unit.

4. The system of claim 2, wherein the memory interface unit is further configured to return to the low power mode subsequent to completion of calibrating of the timing unit and in response to continuing to receive the asserted idle signal.

5. The system of claim 1, wherein the memory interface unit is configured to send a calibration request to the memory controller to initiate a calibration sequence to calibrate the timing unit.

6. The system of claim 5, wherein the memory interface unit is further configured to calibrate the timing unit in response to receiving a calibration acknowledgement signal from the memory controller.

7. The system of claim 1, wherein the memory interface unit is configured to store calibration values within a storage.

8. The system of claim 1, wherein the given predetermined interval corresponds to a programmable value stored within a programmable storage.

9. The system of claim 1, wherein the memory interface unit includes a calibration timer that uses the programmable value to determine whether the given predetermined interval has occurred.

10. The system of claim 1, wherein during operation in the low power mode an operating voltage has been removed from at least a portion of the memory interface unit.

11. A method comprising:
generating, by a memory interface unit, timing signals for controlling read and write access to a memory unit that includes one or more storage arrays; and
calibrating the timing signals at predetermined intervals while the memory interface unit is operating in a normal mode; and
wherein in response to an occurrence of a given predetermined interval while the memory interface unit is operating in a low power mode, calibrating the timing signals subsequent to transitioning the memory interface unit to the normal mode.

12. The method of claim 11, further comprising entering the low power mode in response to receiving an asserted idle signal.

13. The method of claim 12, wherein idle signal is asserted dependent upon memory traffic between a memory controller and the memory unit.

14. The method of claim 12, further comprising returning to the low power mode subsequent to completion of calibration of the timing signals and in response to continued receiving of the asserted idle signal.

15. The method of claim 11, further comprising sending a calibration request to a memory controller to initiate a calibration sequence to calibrate the timing signals.

16. The method of claim 15, further comprising calibrating the timing signals in response to receiving a calibration acknowledgement signal from the memory controller.

17. The method of claim 11, wherein the given predetermined interval is programmable.

18. The method of claim 11, further comprising removing an operating voltage from at least a portion of the memory interface unit to enter the low power mode.

19. The method of claim 11, further comprising stopping from transitioning one or more clock signals distributed to at least a portion of the memory interface unit to enter the low power mode.

20. The method of claim 11, wherein the given predetermined interval has occurred in response to elapsing of a timer unit having a counter.
